(19) United States
(12) Patent Application Publication
(10) Pub. No.: US 2016/0086517 A1
(43) Pub. Date: Mar. 24, 2016

(54) METHOD AND APPARATUS FOR EYE MODEL AND TESTING THEREOF

(71) Applicants: Huayi Gao, Kitchener (CA); Chau Phan, Kitchener (CA)

(72) Inventors: Huayi Gao, Kitchener (CA); Chau Phan, Kitchener (CA)

(21) Appl. No.: 14/490,088

(22) Filed: Sep. 18, 2014

(51) Int. Cl. G09B 23/34

(52) U.S. Cl. CPC G09B 23/34

(57) ABSTRACT

Various embodiments are described herein for two-piece eye models for simulating an eye. The eye model generally has an eyelid member having a concave inner surface to simulate an inner surface of an eyelid; and an eyeball member having a rounded surface for simulating an eyeball and being sized to be releasably received within the concave inner surface of the eyelid member. Other embodiments may include at least one of an eye model holder, a fluidic system and an eye movement unit.

### FIELD

The various embodiments described herein generally relate to an eye model as well as associated methods for fabrication thereof and testing in a variety of applications.

### BACKGROUND

The field of Contact Lenses (CL) is rapidly growing and changing as novel materials are continuously developed each year to enhance overall comfort and ocular health, while limiting production costs. Furthermore, CLs have also evolved rapidly beyond their original intended application in vision correction, extending into other ocular applications such as therapeutic bandages, drug delivery and biosensors. Consequently, as these newer CL materials and applications are developed, undoubtedly there will be an increased demand for better in-vitro testing for efficacy, biocompatibility and microbiology for the CL materials. There is also demand for in-vitro eye models that may be used in other types of applications.

However, the in-vitro eye models that are currently available for testing CLs and other eye related applications are severely limited. For example, due to costs and feasibility, the majority of in-vitro studies for CLs have used a vial containing a certain amount of fluid as an accepted standard for an eye model.

### SUMMARY OF VARIOUS EMBODIMENTS

Various embodiments for an eye model as well as related fabrication methods and testing methods for various applications are provided according to the teachings herein. The eye model is primarily a two-piece eye model but in alternative embodiments, an eye model holder may be used. In alternative embodiments, a fluid system may be added to the two-piece eye model and the eye model holder. In alternative embodiments, an actuation system may be added to the two-piece eye model, the eye model holder and the fluid system. In various alternative embodiments, various functional layers and/or foreign bodies may be added to any of the two-piece eye models described herein. In various alternative embodiments, the eyeball member used in the eye models described herein may have various shapes.

In general, the two-piece eye model may be made at low cost and with high precision provides a robust in-vitro platform for a variety of vision science related applications. In some embodiments, the two-piece eye model may be integrated with a fluidics system and/or actuation system, to emulate daily operations of the human eye or animal eye.

In a broad aspect, at least one embodiment described herein provides an eye model for simulating an eye, wherein the eye model comprises an eyelid member having a concave inner surface to simulate an inner surface of an eyelid; and an eyeball member having a rounded surface for simulating an eyeball and being sized to be releasably received within the concave inner surface of the eyelid member.

In at least some embodiments, the eyelid member and the eyeball member may have a vertical orientation.

In at least some embodiments, at least one of the eyelid member and the eyeball member may be made of polymers comprising at least one of Agar, protein derived polymers, synthetic polymers, polysaccharides, synthetic polymers, hydrogel polymers and elastomers.

In at least some embodiments, at least one of the eye members may comprise one or more functional layers on an outer surface thereof.

In at least some embodiments, one or more functional layers may comprise at least one of collagen, a combination of epithelial cells and collagen, hydrophobic species, hydrophilic species, hydrophobic species, lipids and proteins.

In at least some embodiments, the eye model may further comprises an eye model holder that releasably holds the eyelid and the eyeball members slightly apart from each other to provide a channel therebetween having a channel inlet and a channel outlet.

In at least some embodiments, the eye model holder may comprise a body having an upper surface and lower legs that have flat lower surfaces to provide a stable surface for the eye model holder to stand in an upright position, the legs having inner side walls and the body a having a lower surface that collectively define a cavity to releasably fixedly receive the eye ball and eyelid members.

In at least some embodiments, the eye model holder may comprise two holder portions for holding the eyeball and eyelid members, respectively, the two holder portions having flat lower surfaces to provide a stable support and upper surfaces that are shaped for releasably holding the eyeball and eyelid members, respectively; and at least one gap member for setting a width for a gap between surfaces of the eyelid and eyeball members that face each other.

In at least some embodiments, the eye model may further comprise a fluid system including a fluid source coupled to the channel inlet of the channel between the eyeball members for providing fluid thereto during testing; and a collection well coupled to the channel outlet for receiving the fluid during testing.

In at least some embodiments, the eyeball member may comprise a porous surface layer and an intravitreal space having at least one of a cavity and a porous network.

In at least some embodiments, the eyeball piece may comprise poloxamers to create at least one of the cavity and the porous network.

In at least some embodiments, the eye model may further comprise an eye movement unit to move at least one of the eyeball and eyelid members relative to one another.

In at least some embodiments, the eye movement unit may comprise a control unit configured to control movement of at least one the eyelid and eyeball members; at least one actuator configured to move at least one of the eyelid and eyeball members; and at least one motor coupled to the control unit and the at least one actuator, the at least one motor being configured to receive control signals from the control unit to cause the at least one actuator to move at least one the eyelid and eyeball members.

In at least some embodiments, the eyeball member may comprise at least one foreign body.

In at least some embodiments, the eye model may comprise materials allowing the eye model to be used for at least one of drug discovery, microbiology and toxicology testing.

In at least some embodiments, the eyeball member may comprise a support region, an indented region formed at a top portion of the support region and a cornea region formed at a central portion of the indented region.

In at least some embodiments, the eyeball member may comprise a support region, an indented region formed at a top portion of the support region and a flat region formed at a central portion of the indented region.

At least some embodiments may allow for use of an eye model for drug discovery, where the eye model is defined in accordance with the teachings herein.

At least some embodiments may allow for use of an eye model for microbiology, where the eye model is defined in accordance with the teachings herein.

At least some embodiments may allow for use of an eye model for toxicology, where the eye model is defined in accordance with the teachings herein.

At least some embodiments may allow for use of an eye model for training individuals to remove one or more foreign bodies from an eye, the eye model being defined accordance with the teachings herein.

In another broad aspect, at least one embodiment described herein provides a method for fabricating an eye model, the method comprising producing an eyelid member having a concave inner surface to simulate an inner surface of an eyelid; and producing an eyeball member having a rounded surface for simulating an eyeball and being sized to be releasably received within the concave inner surface of the eyelid member.

In at least some embodiments, the method may further comprise using at least one of Agar, protein derived polymers, synthetic polymers, polysaccharides, synthetic polymers, hydrogel polymers and elastomers to fabricate the eyelid and eyeball members.

In at least some embodiments, the method may comprise forming at least one functional layer on at least one of the eye members.

In at least some embodiments, the method may comprise forming at least one functional layer comprises using at least one of collagen, a combination of epithelial cells and collagen, hydrophobic species, hydrophilic species, hydrophobic species, lipids and proteins.

In at least some embodiments, the method may comprise fabricating the functional layers using at least one of spin coating, dip coating, plasma treatment, and gas treatment depending on the materials used for the eyeball and eye lid members.

In at least some embodiments, the method may further comprise forming an eye model holder that releasably holds the eyelid and the eyeball members slightly apart from each other to provide a channel therebetween having a channel inlet and a channel outlet.

In at least some embodiments, the method may further comprise forming the eyeball piece with an intravitreal space comprising at least one of a cavity and a porous network.

In at least some embodiments, the method may further comprise using poloxamers to create at least one of the cavity and the porous network.

In at least some embodiments, the method may further comprise inserting at least one foreign body in the eyeball member.

In at least some embodiments, the method may comprise fabricating the eyelid and eyeball members using 3D printed molds.

In at least some embodiments, the method may further comprise fabricating the members using direct 3D printing of polymer materials.

In at least some embodiments, the method may further comprise fabricating the eye model from materials that allow the eye model to be used for at least one of drug discovery, microbiology and toxicology testing.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described.

FIG. 1A shows an example embodiment of a two-piece eye model.

FIG. 1B shows an example embodiment of an optional eye model holder for the two-piece eye model of FIG. 1A.

FIG. 1C shows the two-piece eye model of FIG. 1A inserted into the eye model holder of FIG. 1B.

FIG. 1D shows the two-piece eye model of FIG. 1A inserted into an example alternative embodiment of an eye model holder.

FIGS. 2A-2E show various alternative embodiments of the eyeball member that may be used in the two-piece eye model for different applications.

FIG. 3 shows an example embodiment of the two piece eye model coupled with a fluidic system for testing purposes.

FIG. 4 shows a flowchart of an example embodiment of an eye model fabrication method.

FIGS. 5A and 5B show example embodiments of an eyeball member having a porous network and a cavity, respectively, that may be used in a two-piece eye model.

FIG. 6A shows a flowchart of an example embodiment of an eye model fabrication method for making an eye model with an intravitreal space.

FIGS. 6B and 6C show the creation of an eyeball member for an eye model having a porous network and a cavity, respectively, by dissolving scaffold material or cavity material, respectively.

FIG. 7 is a schematic diagram of an eye model testing platform that may be used with the two-piece eye models described herein.

FIGS. 8A and 8B show an example embodiment of control components that may be used in the eye model testing platform of FIG. 7.

FIGS. 8C and 8D show example embodiments of eyeball member actuator assemblies that may be used with an eye model testing platform.

FIGS. 8E and 8F show example embodiments of eyelid member actuator assemblies that may be used with an eye model testing platform.

FIG. 8G shows an example embodiment of a control unit that may be used with an eye model testing platform.

FIG. 9 shows an eyeball member having different concentrations of agarose for each region of the eye and foreign objects embedded in various regions.

Further aspects and features of the embodiments described herein will appear from the following description taken together with the accompanying drawings.

### DETAILED DESCRIPTION OF THE EMBODIMENTS

Various apparatuses or processes will be described below to provide an example of at least one embodiment of the claimed subject matter. No embodiment described below limits any claimed subject matter and any claimed subject matter may cover processes, apparatuses or systems that differ from those described below. The claimed subject matter is not limited to apparatuses, processes or systems having all of the features of any one apparatus, process or system described below or to features common to multiple or all of the apparatuses, or processes or systems described below. It is possible that an apparatus, process or system described below is not an embodiment of any claimed subject matter. Any subject matter that is disclosed in an apparatus, process or system described below that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical or electrical connotation. For example, as used herein, the terms coupled or coupling can indicate that two elements or devices can be directly connected to one another or connected to one another through one or more intermediate elements or devices via an electrical element or electrical signal or a mechanical element depending on the particular context.

It should be noted that terms of degree such as “substantially”, “about” and “approximately” as used herein mean a reasonable amount of deviation of the modified term such that the end result is not significantly changed. These terms of degree may be construed as including a certain deviation of the modified term if this deviation would not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made if the end result is not significantly changed.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Described herein are various example embodiments for an eye model as well as associated methods for fabrication thereof and testing in a variety of applications. The eye model generally comprises two-pieces including an eyelid member and an eyeball member. Various alternative embodiments of the two-piece eye model are described herein which include at least one of different shapes, additional layers and/or additional elements.

The various eye models described herein may be made relatively inexpensively while providing have high precision emulation of the eye. The various eye models described herein may also be used in a variety of in-vitro studies and applications including testing of Contact Lenses (CLs), as will be described.

In addition, in at least some embodiments, the basic two piece nature of the various eye models described in accordance with the teachings herein may be built to allow for high precision control of a thin film of tears which flow vertically, similar to the natural flow of tears in the human or animal eye. An eye model holder may be fabricated and used to precisely control the relative positions of the two pieces of the eye model as well as to provide structural support. To emulate tear secretion and flow in the human eye, a fluidic system may be integrated with the eye model in at least some embodiments.

The eye model members may be manufactured using 3D printing technology to reduce the cost of production. Precise designs of each model member may first be modelled and then the corresponding molds may be 3D printed. Alternatively, the eye model members may be directly 3D printed with printers that are capable of dispensing the selected material(s). In either case, various desired materials may be selected to make the eye model members and synthesis methods that correspond to the selected materials may then be used to fabricate eye model members.

In at least some embodiments, one or more functional layers may then be added to the eye model members by using spin-coating, dip-coating or 3D printing on the surface of the eye model member depending on the materials that are selected for the one or more functional layers. The functional layers are optional but may be added depending on whether certain properties are desired for the eye model members. For example, a hydrogel layer can be coated on the surface of the eyeball member to create a permeable hydrophilic layer for drug diffusion studies. Another example is to coat a layer of collagen on the surface of the eyeball member to facilitate binding of epithelial corneal cells. Another example is to first coat a permeable hydrophilic layer on the surface of the eyeball member and then to coat a layer of collagen on the hydrophilic layer. In alternative embodiments, this layering may be reversed. In alternative embodiments, other regions of the eyeball member 14 may be coated according to these two-layer examples.

In at least some embodiments, the eye model may be integrated with an actuation system to emulate the blinking mechanism of the eye. Lateral movement between the eye model members may emulate the blinking action, whereas rotational movement of the eyeball member emulates natural movements of the eyeball.

In at least some embodiments, the eye model may further be coupled with a fluidics system. When a fluidics system is added to the eye model along with an actuation system, the blink cell may be configured to simulate tear refreshment by using eyelid movement.

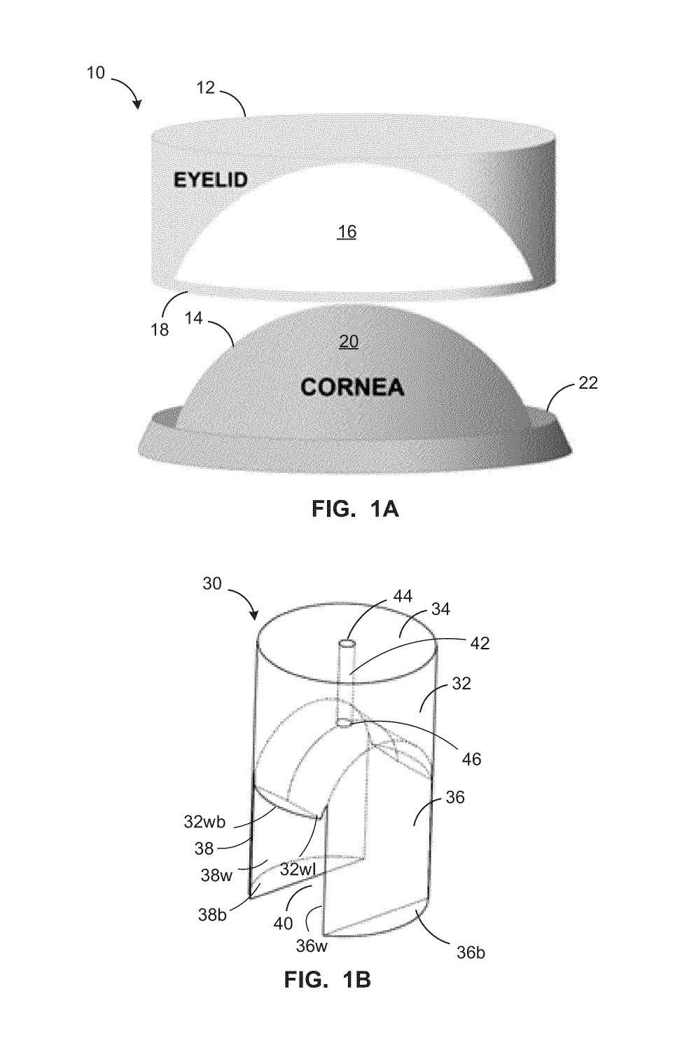

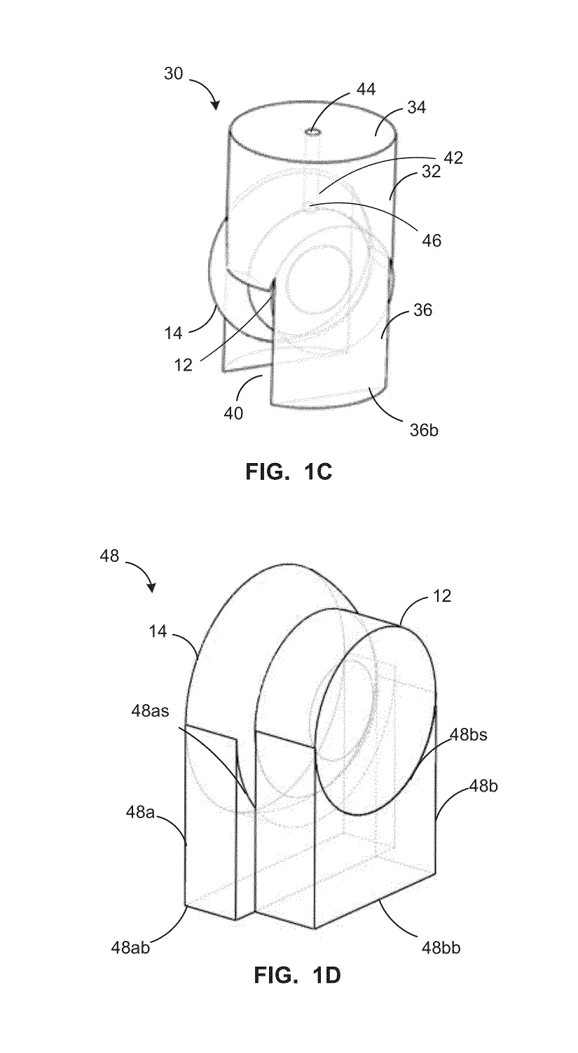

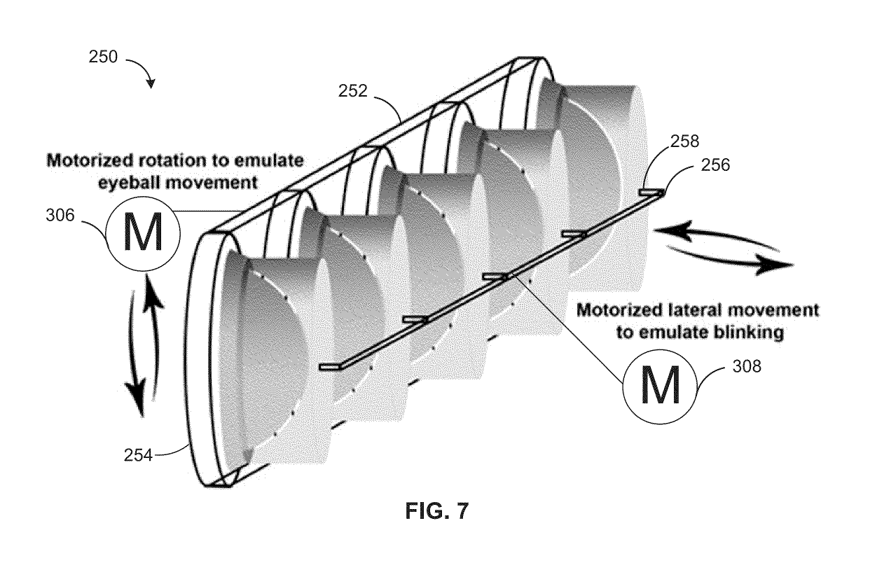

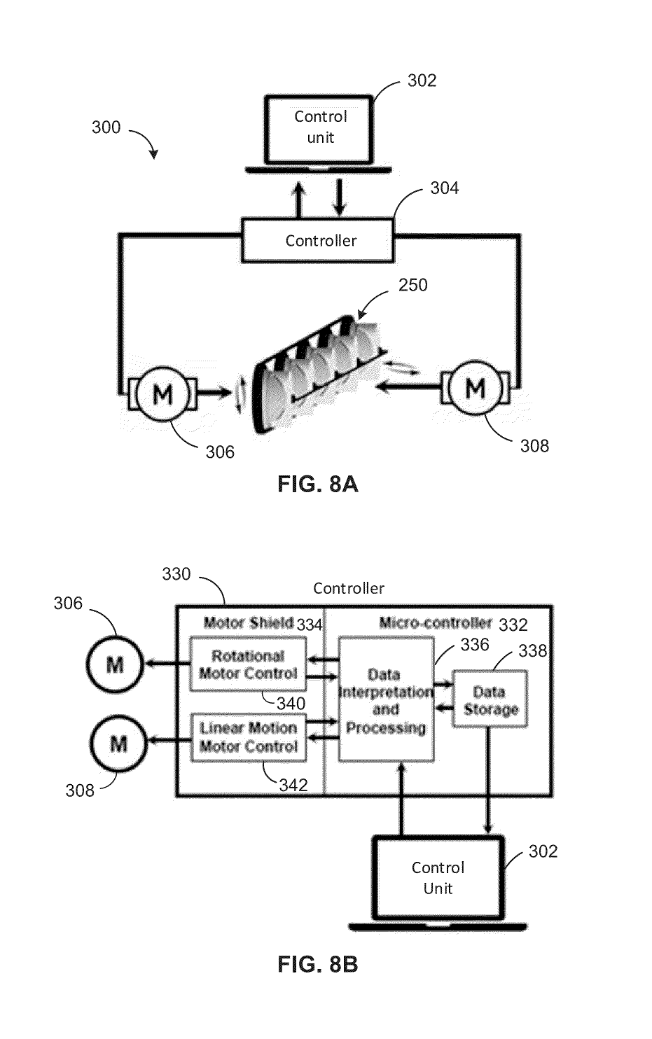

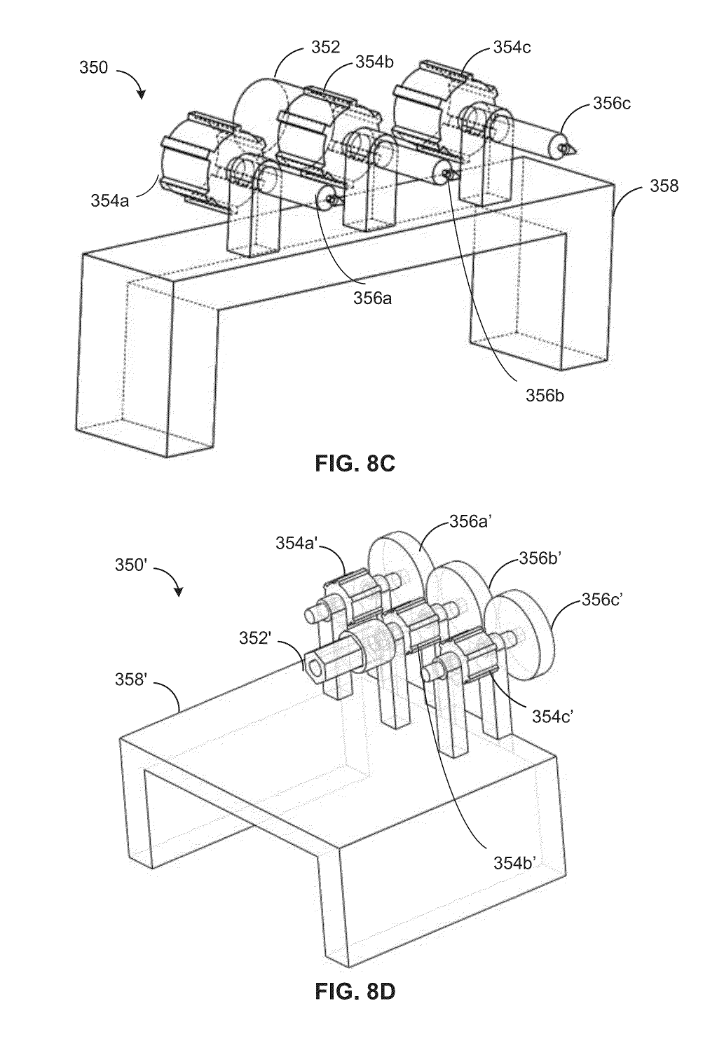

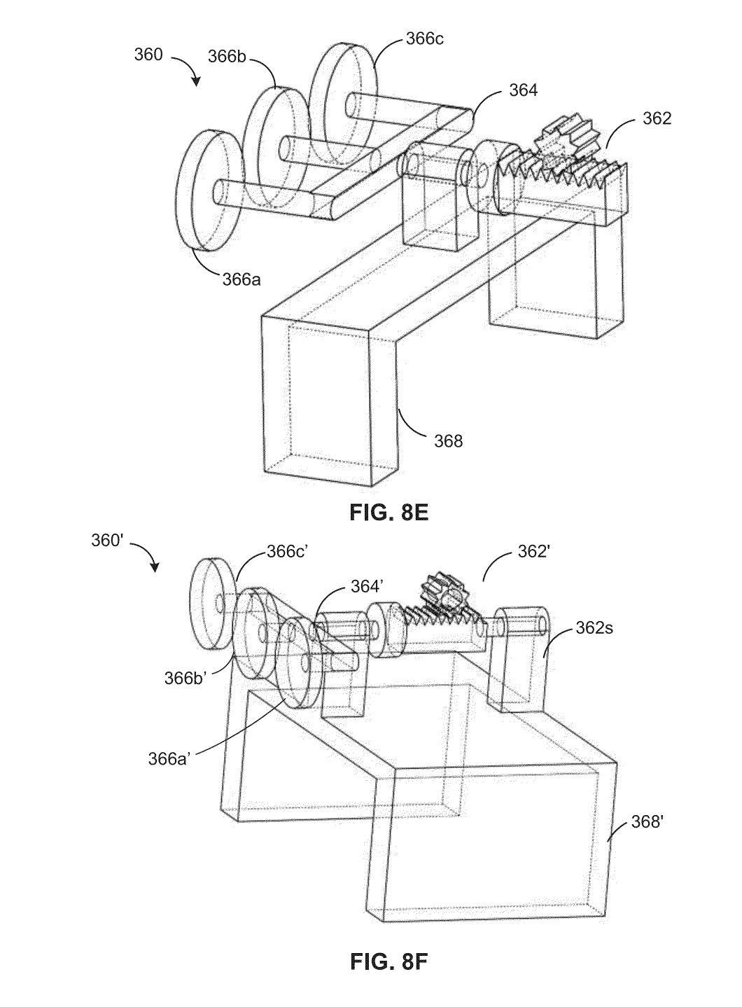

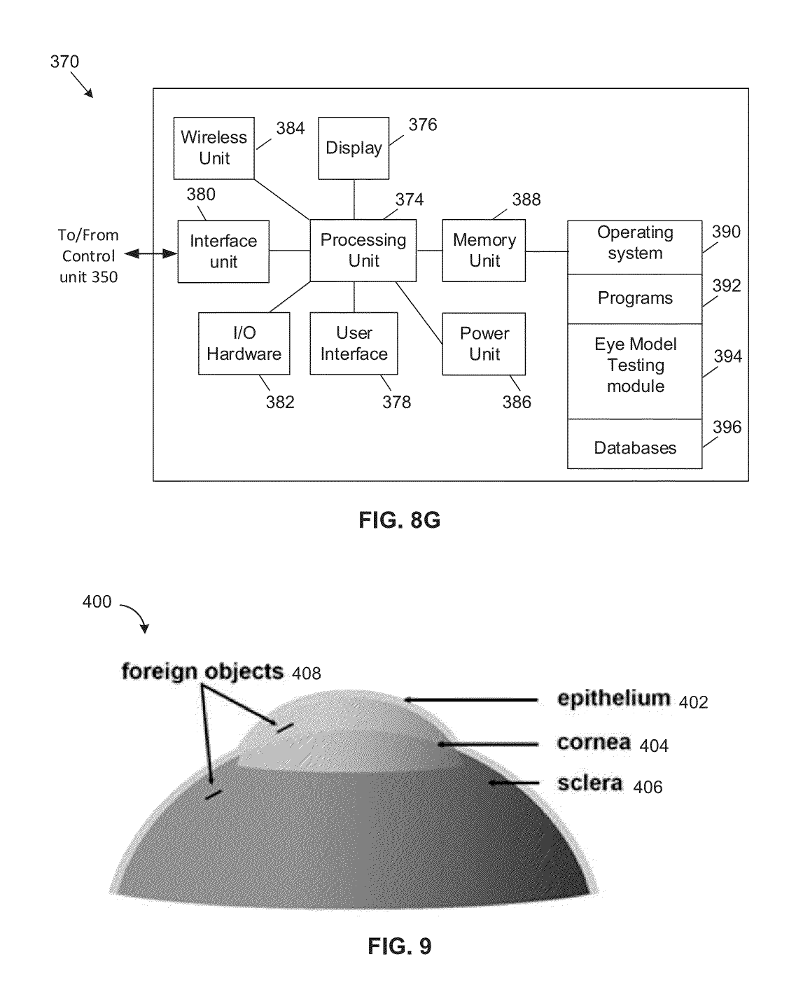

Referring now to FIG. 1A, shown therein is an example embodiment of a two-piece eye model 10 comprising an eyelid member 12 and an eyeball member 14. The eyelid member 10 has a concave inner surface that simulates an inner surface of an actual eyelid and defines a cavity 16. The eyeball member 12 has a rounded surface for simulating an eyeball and is sized to be releasably received within the concave inner surface of the eyelid member 12. The eyeball member 12 includes a cornea region 20. The corresponding surfaces of the cornea region 20 and the eyelid 12 are generally shaped so as to maintain a thin film of fluid between the eyelid member and the eyeball member for testing. The film of fluid may or may not be continuous depending on whether an actuation system is used with the eye model 10, as will be discussed in further detail below with respect to FIGS. 7 to 8G.

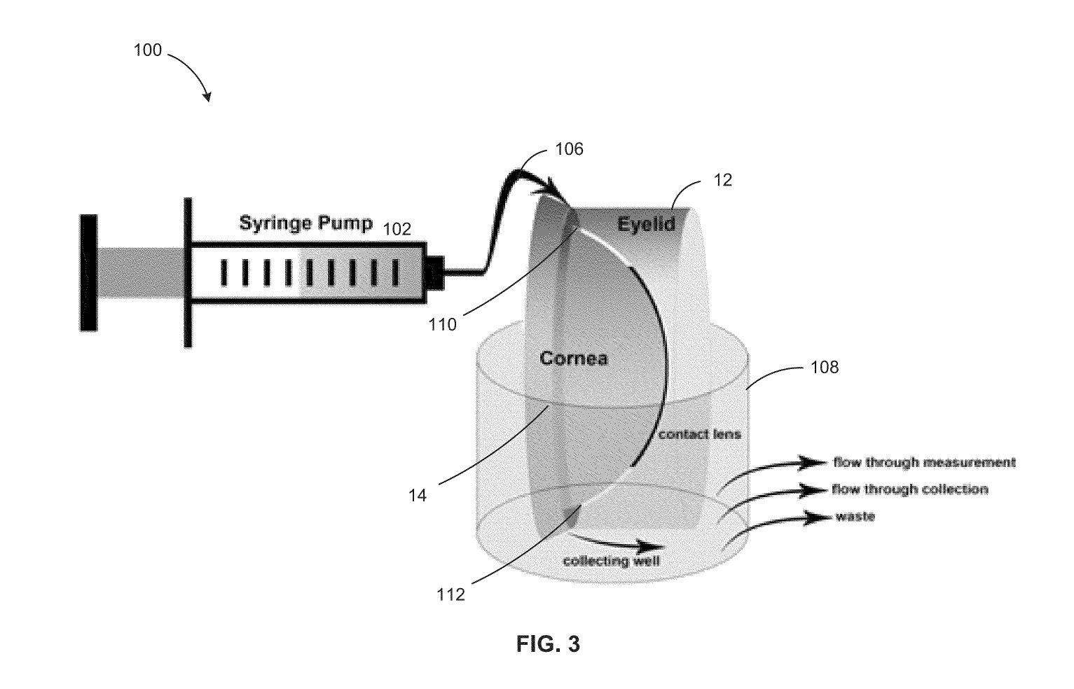

Advantageously, the eye model 10 includes two pieces, unlike other conventional eye models. The two piece design of the eye model 10 improves the ease of manufacture of the eye model 10 and the assembly of the eye model with another object, such as a contact lens, for example. In addition, the two-piece eye design of the eye model 10 may be used to create a low and even tear fluid volume, e.g. less than 100 μL, between the simulated eyelid and cornea during use, as will be described in more detail with respect to FIG. 3.

In this example embodiment, the eyelid and eyeball members 12 and 14 have smooth outer surfaces but in alternative embodiments, the eyelid and eyeball members 12 may have irregular surfaces for simulating a variety of different conditions and for testing in various applications. For example, contact lens discomfort can result from friction caused by the eyelid rubbing on the cornea.

In this example embodiment, the eyeball member 20 includes an outer rim or flange 22 that receives a ring or lower edge 18 that is disposed at the bottom of the eyelid member and may sit on the flange 22 when the eye model 10 is assembled. The flange 22 and ring 18 may help orient and fix the two members 12 and 14 with respect to one another.

It should be noted that in some alternative embodiments the ring 18 has a height such that a channel (such as that shown in FIG. 3) exists along and between the surfaces of the eyelid member 12 and the eyeball member 14 when they are assembled into the eye model 12.

In such embodiments with a channel between the eyelid 12 and eyeball members 12 and 14, there may also be at least two apertures (not shown) that may be diametrically opposed from one another and formed on either side of the channel for allowing fluid to enter and exit the channel during use. In these embodiments, at least one of the eyelid member 12 and the eyeball member 14 include these apertures for receiving and disposing of a fluid during use. Alternatively, in these embodiments, there may be several sets of apertures that are formed to provide entry into and exit from the channel and these apertures may be formed at different circumferential areas of at least one of the eyelid and eyeball members 12 and 14.

In other embodiments, the eye model 10 may include a third member for holding or clamping the eyelid and eyeball members 12 and 14 together in a desired position. Referring now to FIG. 1B, shown therein is an example embodiment of an optional eye model holder 30 for the two-piece eye model 10. The eye model holder 30 basically includes a first portion for holding the two piece eye model. In some cases, as is shown in FIG. 1B, the eye model holder 30 may include an optional channel for sending fluid to the eye model for testing. Various configurations exist for the eye model holder 30 and the embodiment shown in FIG. 1B, should only be considered as one example embodiment of which many are possible.

In the example embodiment of FIG. 1A, the eye model holder 30 comprises a first portion for holding the eye model members 12 and 14, a second portion for providing fluid to the eye model members 12 and 14 in use and a third portion that provides a base or a stand. In particular, the eye model holder 30 comprises a body 32 having an upper surface 34 and lower legs 36 and 38 that provide a base for the eye model holder 30. The legs 36 and 38 have flat lower surfaces 36b and 38b to provide a stable surface for the eye model holder to stand in an upright position.

The legs 36 and 38 also have inner side walls 36w and 38w that define a cavity therebetween 40 which is large enough to receive the eye model members 12 and 14. The body 32 of the eye model holder 30 also has lower surfaces 32wb and 32wl at the upper portion of the cavity 40. The lower surface 32wb is contoured to releasably fixedly receive the eyeball member 14 and accordingly is curved to correspond to the curvature of the outer surface of a portion of the flange 22 of the eyeball member 14. Likewise, the lower surface 32wl is curved to correspond to the curvature of the outer surface of a portion of the eyelid member 12. The lower surfaces 32wb and 32wl may be shaped and dimensioned so as to provide a releasable friction fit with the eyeball and eyelid members 14 and 12, respectively, as is shown in FIG. 10, for example.

The legs 38 and 40 can have different shapes as long as a cavity 40 is provided therebetween so that the eye model members 12 and 14 may be inserted into the eye model holder 30 so that they are held at a given orientation and a given spacing relative to one another. In this example, the eye model members 12 and 14 are held in a vertical orientation. However, in alternative embodiments, the stands 38 and 40 may be shaped so that the cavity 40 is at an angle instead of being vertical in order to hold the eye model members 12 and 14 at that angle.

In this example embodiment, the eye model holder 30 further comprises a channel 42 having an inlet aperture 44 and an outlet aperture 44. This allows the eye model holder 30 to be attached or otherwise coupled with a fluid system that provides a fluid to the eye model members 12 and 14 during use for testing purposes. Accordingly, the upper surface 34 of the body 32 of the eye model holder 30 may be shaped to receive a portion of the fluid system (not shown). In addition, the inner walls 32wb and 32wl may be shaped so that the eye members 12 and 14 are slightly separated to define an eye member channel between them. The outlet of the channel 42 is aligned to the eye member channel so that fluid from the channel 42 passes to the eye member channel and flows between the eye members 12 and 14. The fluid then exits at another portion of the edge of the eye members 12 and 14, such as the portion that is generally opposite the channel outlet 46, for example, although other configurations may be possible.

Referring now to FIG. 1D, shown therein is an example of an alternative embodiment of an eye model holder 48 having two holders 48a and 48b for holding the eyeball member 14 and the eyelid member 12, respectively. In this example, one edge of the holders 48a and 48b has a flat lower surface 48an and 48bb, respectively, to provide a stable support for the eye model 10 and allow the holders 48a and 48b to be mounted on a flat surface. It is possible in alternative embodiments for the surface 48ab and 48bb to be shaped different or to have apertures or posts allowing the holders 48a and 48b to be mounted to a platform, such as an eye model testing platform.

The holders 48a and 48b also have upper surfaces 48as and 48bs, respectively, which are shaped for releasably holding the eyeball and eyelid members 14 and 12, respectively. In this example, the upper surfaces 48as and 48bs are curved but in other embodiments they may have different shapes depending on the outer shapes of the eyelid and eyeball members 12 and 14. In some cases, the surfaces 48as and 48bs may be shaped so that corresponding surfaces of the eyeball and eyelid members 14 and 12 sit on the holders 14 and 12. In other cases, the surfaces 48as and 48bs may be shaped to form a releasable friction fit when the corresponding surfaces of the eyeball and eyelid members 14 and 12 are mounted thereon.

The holders 48a and 48b may also be shaped so that a gap exists between the eyelid member 12 and the eyeball member 14 when they are mounted on the holder 48. This gap may be used to allow a thin film of tear fluid to flow between the eyelid and eyeball members 12 and 14. To allow for this gap, at least one of the holders 48a and 48b may have one or more gap members (not shown), such as at least one rectangle, at least one circle or at least two posts on the surfaces of the holders 48a and 48b that are adjacent one another in use. In some cases, the gap members may be adjustable to change the size of the gap between the eyelid and eyeball members 12 and 14. In this case, the gap members may be screws, for example, that may be turned to provide a different gap size.

In some alternative embodiments, there may be cases in which the eyelid and eyeball members 12 and 14 each comprise a retaining member (not shown) that is oriented near the outer surface of the eye holder members 48a and 48b that are opposite one another. Each retaining member may be flexible and is parallel with the outer surfaces of the eyelid and eyeball members 12 and 14 so that during use the eyeball member 14 may be slid onto the holder 48a such that the flat surface of the eyeball member 14 is adjacent to the retaining member which urges the eyeball member 14 towards the eyelid member 12 and holds the eyeball member 14 in place during use. Likewise, the eyelid member 12 may be slid onto the holder 48b such that the flat surface of the eyelid member 12 is adjacent to the retaining member, which urges the eyelid member 12 towards the eyeball member 14 and holds the eyelid member 12 in place during use. For example, the retaining member may be a cantilever. In some embodiments, the retaining member may be a clamp.

It should be noted that in alternative embodiments, the first and second holders 48a and 48b of the eye model holder 48 may be provided by a single structure having two portions where the first portion is analogous to the first holder 48a and the second portion is analogous to the second holder 48b.

It should be noted that the eye model holders 30 and 48 facilitate simple and robust attachment to a fluid system, such as a microfluidic device, for example. In addition, unique to the eye model 10 with the eye model holders 30 and 48 is the vertical orientation of the eye model members 12 and 14, which correctly simulates the natural eye position during the day, and utilizes gravity to generate a natural flow when testing the eye model with fluids. It should also be noted that the eye model holders may be modified for use with any of the eyeball and eyelid members described in accordance with the teachings herein.

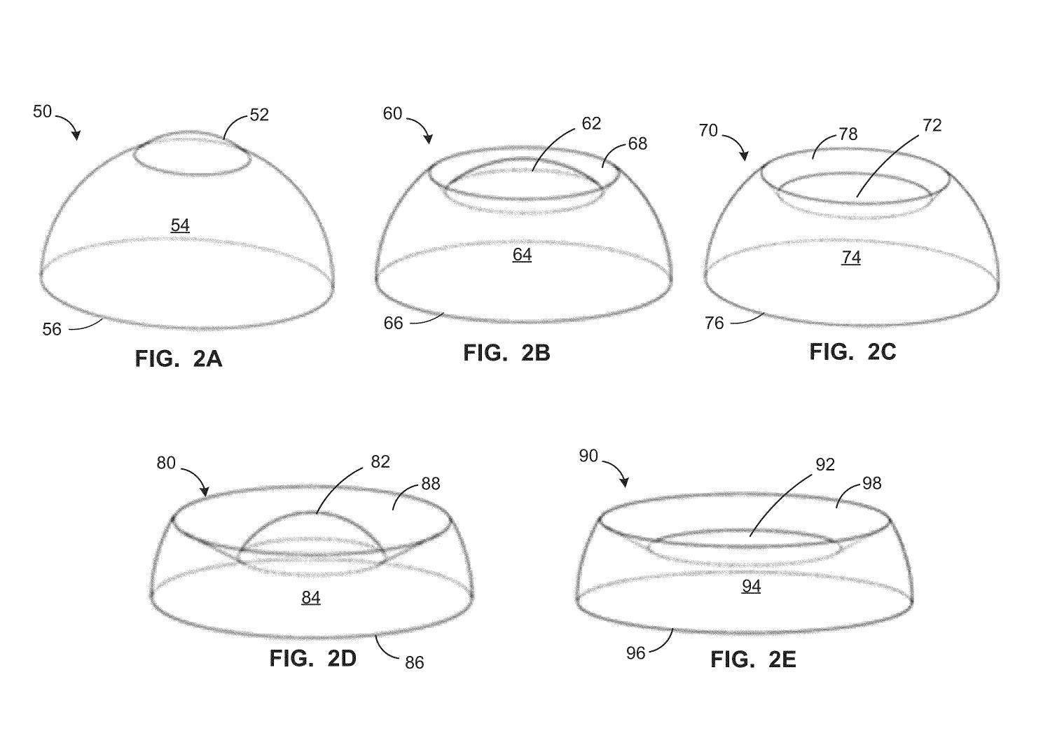

Referring now to FIGS. 2A-2E, shown therein are various alternative embodiments of the eyeball piece that may be used in the two-piece eye model for different applications. Each design also has a supplementary eyelid piece (not shown) to maintain a thin film of fluid within the eye model system between the eyelid member and the eyeball member. Different designs might be desirable if a given application of the eye model requires flat or curved surfaces or if different curvatures or surface areas are required.

The various two-piece eye embodiments in accordance with the teachings herein are robust to adapt to different design specifications with regards to application needs. Example of parameters that may be changed for a certain design include, but are not limited to, cornea and sclera curvatures and radius, having a flat or a flexible surface for the eyelid and eyeball members, surface area of eyelid and eyeball pieces, surface roughness of eyelid and eyeball pieces, and a surface indent or extrusion on the eyeball member.

For example, FIG. 2A shows an alternative embodiment of an eyeball member 50 with a cornea region 52 on top of a conjunctiva region 54, and a flat base 56 having no flange. Accordingly, the eyeball member 50 includes the typical parts of a human or animal eyeball being the conjunctiva (e.g. white part of the eye) and the cornea. The cornea region 52 has a different curvature and protrudes from the conjunctiva 54, and is typically visible from a side view of the eyeball. Because the cornea region 52 is very small, sometimes it's not necessary to be included in an eye model and therefore the cornea region 52 is optional. The eye model 50 may be used for studies that require differences in certain properties of the cornea and the conjunctiva regions 52 and 54, such as studies including, but not limited to drug diffusion studies, corneal toxicology, and microbial penetration.

As another example, FIG. 2B shows an alternative embodiment of an eyeball member 60 with an indented region 68 having a cornea region 62 at a middle portion thereof on top of a support region 64, and a flat base 66 having no flange. The indented region 68 may be used to create a cavity for studies that require the cornea 62 to be submerged in a tear fluid or another fluid, for example. Accordingly, the eyeball member 60 may be used in an eye model for studies such as, but not limited to, any studies where a microfluidic system is not available or obtainable, or is not needed.

As yet another example, FIG. 2C shows an alternative embodiment of an eyeball member 70 with an indented region 78 having a flat region 72 at a middle portion thereof on top of a support region 74, and a flat base 76 having no flange. The flat region 72 may be used to test objects that may have a similar shape or objects that may be used to interact with an eye during use. For example, the eyeball member 70 may be used in an eye model 70 to rapidly test flat lens materials and/or flat biosensors.

As yet another example, FIG. 2D shows an alternative embodiment of an eyeball member 80 that is similar to the eyeball member 60. However, the eyeball member 80 has a larger indented region 88 having a larger cornea region 82 at a middle portion thereof on top of the body 84, and a flat base 86 having no flange. Accordingly, the eye model 80 has more volume to receive a fluid during testing due to the increased space created by the indented region 88.

As yet another example, FIG. 2E shows an alternative embodiment of an eyeball member 90 that is similar to the eyeball member 70. However, the eyeball member 90 has a larger indented region 98 having a larger flat region 92 at a middle portion thereof on top of the body 74, and a flat base 56 having no flange. Accordingly, the eye model 80 has more volume for region 98 and area for the flat region 92 for receiving larger objects for testing such as, but not limited to, lenses or biosensors, for example.

In the various embodiments of the eye model described in accordance with the teachings herein, it should be noted that the eyeball member may be made to have a radius that ranges from about 10 mm to about 15 mm for human eye models. Alternatively, the eyeball member may have a radius that ranges from about 1 mm to about 100 mm for animal eye models. In addition, the eyelid and eyeball members may have a surface area that range from about 0 mm² to about 10 m², a surface roughness of about 1 nm to about 10 mm, and a flat or flexible surface with a radius of curvature from about 0 mm to 30 mm.

Referring now to FIG. 3, shown therein is a schematic of an example embodiment of a two piece eye model coupled with a fluid system 100 for testing purposes. The fluid system 100 comprises a fluid source 102, a fluid conduit 106, and a flow through collector 108.

In this example, the fluid source 102 is a syringe pump, the fluid conduit 106 may be a tube and the flow through collector 108 is a collecting well (available from Corning). In some embodiments, a flow-through collecting device such as a 12-well plate may be used when there are multiple eye models that are coupled to fluid sources and being tested. It should be understood that in other embodiments, other elements may be used for these components. For example a pipette may be used to provide the fluid source 102 and the fluid conduit 106.

The components of the fluid system 100 may be held in place by a portion of the eye model holder (not shown) in some cases. In other cases, a clamp may be used to hold the fluid source 102, fluid conduit and fluid collector 108 relative to the eye model members 12 and 14. The eye model or claim allows for consistent administration of fluid into the system. Furthermore, the gap between the eye model members 12 and 14 may also be precisely maintained by the eye model holder or clamp, so that the fluidic volume inside the eye model is well controlled.

Unlike other conventional eye models, the eye model members 12 and 14 may be positioned relative to one another, in accordance with the teachings herein, to create a low and even tear fluid volume (for example, less than 100 μL to about 60 μL) between them which is closer than conventional eye models to what is typical of a human eye or an animal eye. For instance, studies observing in-vitro depositions of tear protein¹ and lipid² were performed by incubating CLs in a vial containing to 1-2 mL of incubation fluid. For drug delivery using CLs, release studies were performed in vials containing 2-5 mL of release buffer.³⁻⁷ However, these parameters are not reflective of the ocular microenvironment since ocular tear volume is only about 7.0±2 μL⁸, with an average tear flow rate of 0.95-1.55 μL/min.⁹ Such, values for the tear volume and tear flow rate are possible with the different eye model embodiments described in accordance with the teachings here.

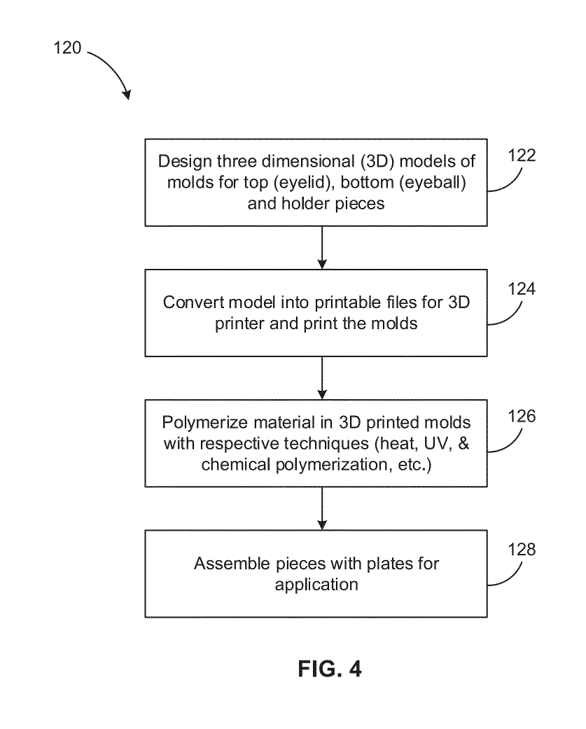

Referring now to FIG. 4, shown therein is a flowchart of an example embodiment of an eye model fabrication method 120 for fabricating the pieces of an eye model and optionally an eye model holder in accordance with the teachings herein. In the example embodiment shown in FIG. 4, the eye model holder 30 is also fabricated.

At 122, the method 120 may comprise creating 3D models for molds of the eye model members including the eyelid member, the eyeball member and optionally the eye holder. The 3D models may be created using a suitable 3D design software package such as AutoCAD® or Solid Works, for example. The 3D models specify the size, shape and texture of the eye model members and optionally the eye model holder. The 3D models are then converted to files that may be interpreted by 3D printers that are compatible with biomaterials. These 3D printers then print the 3D models of the eye model pieces directly, or their corresponding molds.

At 124, the method 120 may comprise converting the 3D models for the eye model members and optionally the eye model holder into print files. The 3D models may then be used by a 3D printer to produce the molds for the eye model members and optionally the eye model holder. The 3-D printed molds facilitate the synthesis process, allowing for the fabrication of the eye model members at a rapid and inexpensive rate.

At 126, the method 120 may comprise filling the molds of the eye model members and optionally the eye model holder with a suitable material to create these elements. Layers of different materials may be used depending on the desired composition of the eye model members. Examples of materials that may be used include, but are not limited to, a polymer including at least one of Agar, protein derived polymers such as collagen, synthetic polymers such as Polydimethylsiloxane (PDMS), polysaccharides, synthetic polymers, hydrogel polymers and elastomers depending on the desired properties for the eye model members and the applications thereof. Various examples of suitable materials are shown in Table 1.

In one embodiment, the synthetic polymer may be a silicon-containing polymer, such as a polysiloxane or polysilane. In another embodiment, the polysiloxane may be a polyalkylsiloxane or polyarylsiloxane. One example of a polyalkylsiloxane is poly(dimethyl)siloxane (PMDS).

TABLE 1
Examples of Materials to Make the Eye Model Members

| Group | Examples |
|---|---|
| Agar | Agarose, Blood agar, Chocolate agar, Nutrient agar, |
| | Sabouraud agar, Tryptic soy agar, Potato dextrose agar |
| Protein derived | Gelatin, sericin, collagen type I and II |
| polymers | |
| Polysaccharides | Chitosan, Dextran |
| Synthetic | Polydimethylsiloxane (PDMS), poly-lactic acid (PLA), |
| polymers | poly(lactic-co-glycolic acid) (PLGA), polyethylene |
| | glycol (PEG) |
| Hydrogel | Acrylamide, acrylic acid, salts of acrylic acid such as |
| polymers | sodium and sulfopropyl acrylates, 2- |
| | hydroxyethylmethacrylate |
| Elastomers | Polyurea and polyuria derivatives |

At 126, after filling the molds of the eye model members and optionally the eye model with suitable material, the method 120 may further comprise polymerizing using respective techniques depending on the type of materials that were used. For example, at this point the method 120 may comprise applying at least one of heat polymerization, UV polymerization and chemical polymerization to the materials to produce the eye model members and optionally the eye model holder. For example, heat and UV polymerization may be used as part of spin coating and dip coating. The decision of which type(s) of polymerization to use depends on the materials that are used.

At 128, the method 120 may comprise separating the eye model members from the 3D molds and then assembling the eye model members with a collection plate, which may be optional and may be used when the eye model is integrated with a fluidic system.

It should be noted that the fabrication approach outlined by method 120 allows for flexibility in creating different inexpensive eye models, by using various materials or combinations of materials that make the eye model suitable for use in various applications such as, but not limited to, drug delivery, toxicology and microbiology. For example, when using the eye model for testing in drug discovery or toxicology, any material listed in Table 1 may be used. When the eye model is used for testing in microbiology, at least one of agar, protein derived polymers and polysaccharides may be used.

It should be noted that for various topical studies, the cornea region or the entire eyeball member, depending on the nature of the study, may be coated with one or more functional layers such as, but not limited to, epithelial cells, collagen, hydrophobic and hydrophilic species, polymers, lipids, proteins and drugs. This may be done after act 126 in an alternative embodiment of the method 120 as adding functional layers is optional. Plasma treatment of the eye model members after the functional layers are created may be used to accurately control the hydrophobicity of the eye model members.

For example, the functional layer may comprise PDMS and may be used for studies including, but not limited to, general drug delivery studies, for example. Alternatively, the functional layer may comprise PDMS coated with HEMA and may be used in studies including, but not limited to, drug delivery and toxicology, for example. Alternatively, the functional layer may comprise Agar and may be used in studies including, but not limited to, Drug penetration, toxicology and microbiology. Alternatively, the functional layer may comprise Agar coated with HEMA or the functional layer may comprise Agar with collagen coating and may be used in various studies including, but not limited to, drug delivery, toxicology and microbiology. In general, the type of materials that are used for one or more coatings depends on the specified research, and the level of complexity the research requires.

In embodiments in which biochemical molecules are used for the eye model such as, but not limited to, lipids and proteins, for example, spin-coating and dip-coating, may be utilized so that an even thin film may be deposited on the surface of at least one of the eyeball member and the eyelid member.

In embodiments in which hydrophobic and/or hydrophilic species are used in one or more functional layers on the eye model, plasma and gas may be used to form these functional layers. This involves placing the material in a chamber for plasma coating.

In embodiments in which epithelial cells are grown on the eyeball or eyelid members, a layer of collagen forming a 3D matrix may be used as immobilization sites. The 3-D collagen matrix may either be directly printed using 3D printing, or polymerized after the material is placed within the 3D printed molds. The 3-D collagen matrix may be fabricated in the shape of an eyeball. Thereafter, layers of epithelial cells may be grown on the curved surface of the eyeball by using an appropriate aqueous medium and incubation. Layers of epithelial cells may be formed until a desired number of layers are achieved. This allows the eye model members to be used as a more precise, realistic and viable in-vitro model for a variety of studies such as, but not limited to, studying the interactions between the eye model and various systems, including CLs, ocular inserts, drugs, bio-molecules, microbiology and toxicology studies, for example. For example, 3D collagen culture platforms may be developed for the purpose of investigating reciprocal interaction between an extra cellular matrix (ECM) and cells under various conditions¹. While conventional eye models may be limited by their low throughput screening method, the eye models that are created in accordance with the teachings herein including method 120 and variants thereof are inexpensive, and easy to produce such that they can be used as consumables for high-throughput testing.

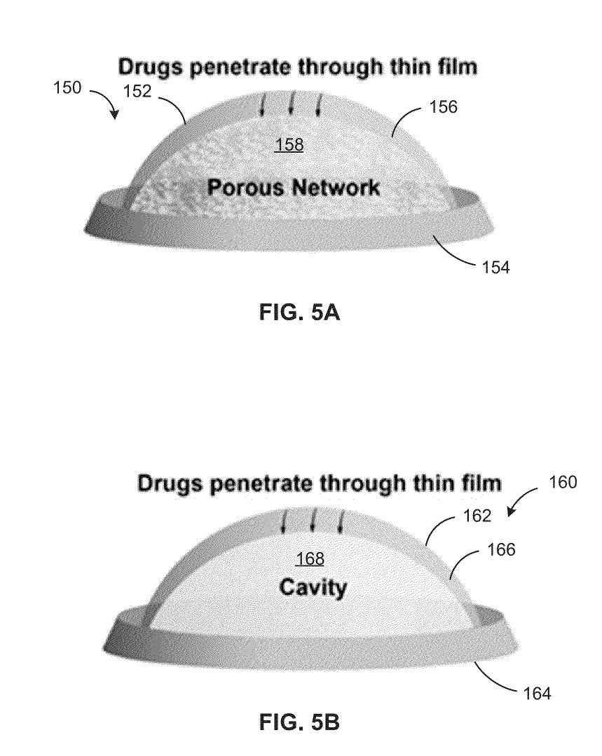

Referring now to FIGS. 5A and 5B, shown therein are example embodiments of eyeball members 150 and 160 having a porous network 158 and a cavity 168, respectively, that may be used in a two-piece eye model. The porous network 158 and the cavity 160 are examples of intravitreal spaces that are surrounded by thin penetrable layers 156 and 166 that form the surface layers 152 and 162, respectively, for the cornea. An eye model having an eyeball member with an intravitreal space better emulates the inside of a human eye or an animal eye.

The surface layers 152 and 162 may be made to have a desired degree of porosity by changing the cross-linking density and concentration of the materials that are used to form the surface layers. Varying the porosity of the surface layers 152 and 162 may be useful for drug testing studies.

The eyeball members 150 and 160 may be used in different applications including, but not limited to, drug delivery studies, for example. In particular, the absorption rate of drugs by the human eye or the animal eye may be of interest since the rate at which drugs or other materials of interest penetrate the thin layers 156 and 166 may be determined to quantify the effects of these materials on the human eye or the animal eye. In the case of drug delivery, the absorption rate of drugs by the eyeball determines various fundamental design parameters for the drug such as, but not limited to, dosage, delivery schedule and release profile, for example.

In at least some embodiments, the eyeball members 150 and 160 with the porous network 158 and the cavity 168, respectively, may be used in combination with a thin epithelial layer on the curved surface of the eyeball members 150 and 160 to provide information for microbiology, toxicology, and drug delivery studies. All of the materials listed in Table 1 are polymers, and so they all may be used for these applications.

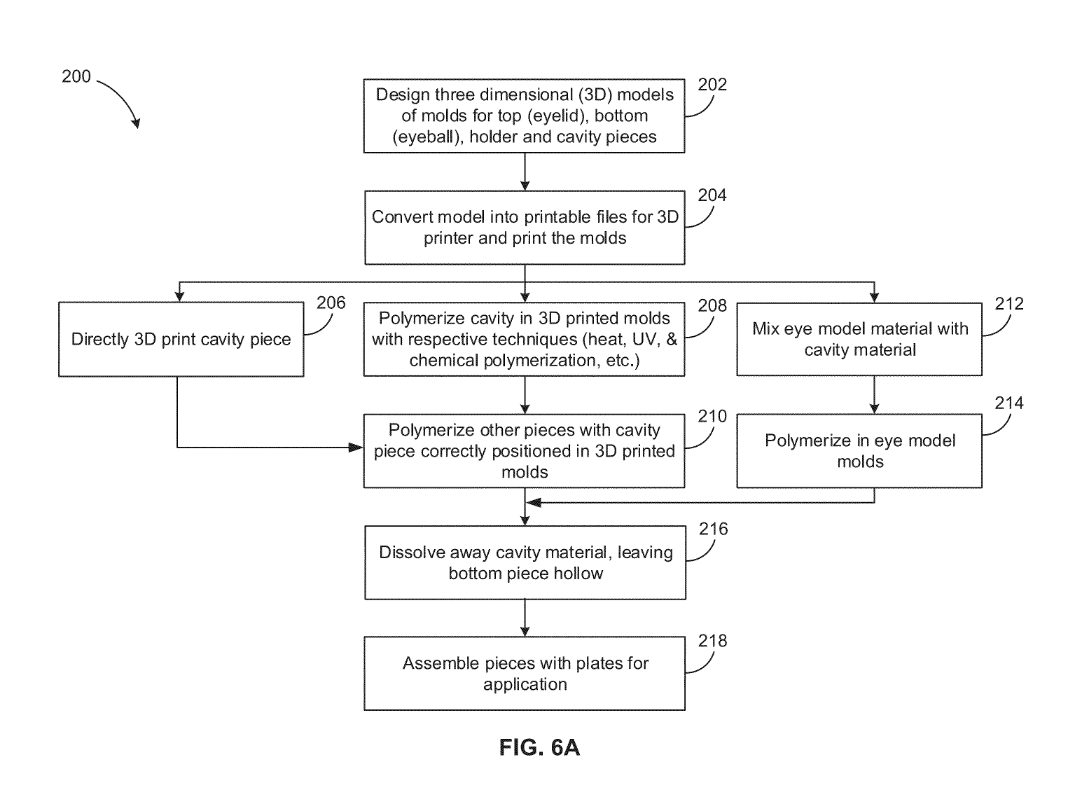

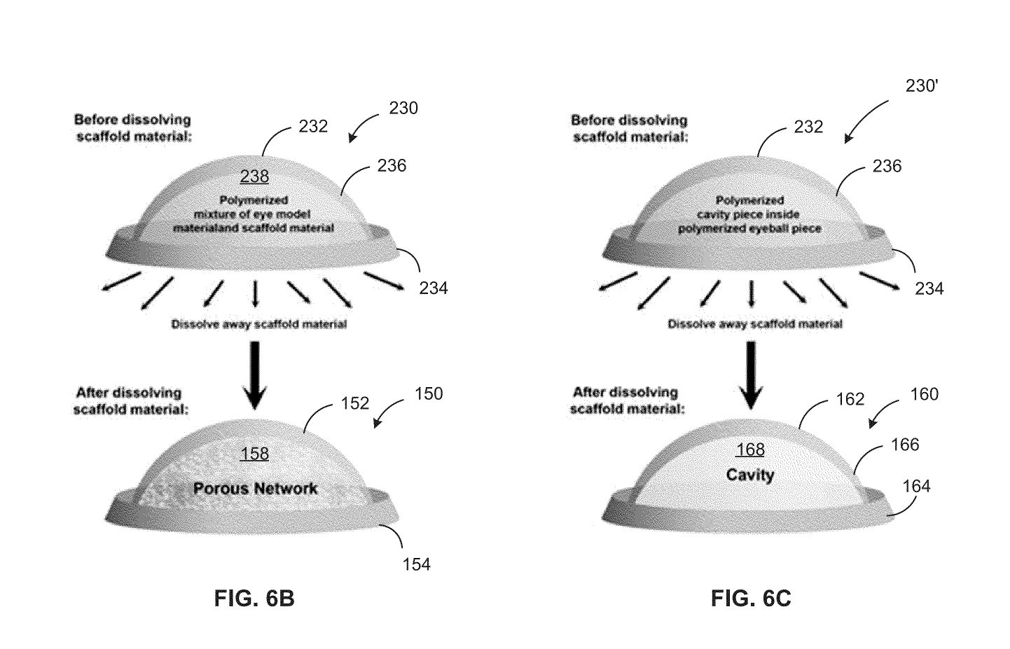

Referring now to FIG. 6A, shown therein is a flowchart of an example embodiment of an eye model fabrication method 200 for making an eye model with an intravitreal space. In order to create the cavity within the eyeball member, scaffold material having the desired shape of the cavity is first fabricated, and later dissolved away after formation of the eye model member. The scaffold materials that may be used include, but are not limited to, poloxamers, poly-lactic acids, poly-glycolic acids, and poly-ethers. Three techniques may be used to create the scaffold structure depending on the complexity of the structure will be described with reference to FIG. 6A.

At 202, the method 200 may comprise creating 3D models of molds for the eye model members as in 122 or method 120 except that a mold is also made of the cavity member. When the materials used for this mold are polymerized, an additional piece, which may be solid, may be put in the mold to create the cavity. This shape and size of this additional piece may vary depending on the shape and size of the desired cavity.

Act 204 of method 200 is similar to act 124 of method 100. However, act 126 of method 100 has been separated into 3 different possible acts depending on the complexity of the structure used within the eyeball member for the intravitreal space.

For example, if the structure for the intravitreal space is simple, such as a hemispherical cavity for example, then a mold may be used to create a desirable shape during the polymerization process at act 208 (otherwise act 208 is similar to act 128). However, if the intravitreal space involves using a more intricate scaffold structure, then it may be directly 3D printed while being polymerized as in act 206. In both of these cases, after acts 206 and 208 the method 200 then proceeds to 210 at which point the other pieces of the eye model and optional the eye model holder may be polymerized with the cavity correctly positioned in the 3D printed mold for the eyeball member.

As another option, if a micro-scale porous network having pores with sizes in the micro meter range (such as less than about 1,000 micro-meters, for example) is desirable for the intravitreal space, then the scaffolding material may be mixed with eye model material, using an appropriate mixing technique, while it's half polymerized in act 212 so that it may later be dissolved out as shown in FIGS. 6B and 6C, for example. For example the mixing technique may include other processes such as emulsion and homogenization to obtain a good mixture. The method 200 then proceeds to act 214 at which point the eye model members and optionally the eye model holder are polymerized.

At both act 208, 210 and 214, the polymerization may be done as was described for act 126 of method 100 in which a polymerization technique may be selected depending on the type of material that is used when filling the molds of the eye model members and optionally the eye model holder.

At 216 of the method 200, the cavity or scaffolding material may be dissolved which leaves the desired intravitreal space within the eyeball member. For example, thermoresponsive poloxamer 407 can be used to create a gel within the eye model at temperatures above 30° C. After the eye model is created, the temperature can be lowered to 4° C. degrees to liquefy the poloxamer, which can then be eluted from the eye model. Examples of this dissolving act are illustrated in FIGS. 6B and 6C which show the creation of an eyeball member for an eye model having a porous network and a cavity, respectively, by dissolving scaffold material or cavity material, respectively.

At 218 of the method 200, the eye model pieces are coupled with plates for a particular application and the eye model pieces may then be placed in storage or in a package for eventual delivery to a customer.

Referring now to FIG. 7, shown therein is a schematic diagram of an eye model testing platform 250 that may be used with at least some of the two-piece eye models described herein. The eye model testing platform 250 may comprise an eye movement simulation mechanism so that at least one of the eye members may move during testing to emulate natural eye movements. In this example embodiment, the eye movement simulation mechanism uses motorized movements of the eyelid member and the eyeball member to emulate natural eye movements and the blinking process of a human or animal eye.

It should be understood that in alternative embodiments, a fluidic system may be integrated with the eye model testing platform 250 to also simulate various aqueous environments or conditions that may be experienced by real eyes in-vivo. For instance, the fluidic system shown in FIG. 3 is an example of a fluidic system that may be integrated with the eye model testing platform 250. Accordingly, the eyelid member of the eye models may be modified to have inlet and outlet apertures, so that each blinking motion refreshes a basal tear film between the eyelid and eyeball members with a new liquid layer.

In this example embodiment, the eye model testing platform comprises a support member 252, actuators 254 and 256 and motors 306 and 308 as well as mounting members or anchors that may provide structural integrity. Each of the motors 306 and 308 may be implemented using any type of suitable motor such as, but not limited to, electric motors (e.g. step or servo motors) and piezoelectric motors (which may be used for finer control). The actuators may generally be any suitable electric, piezoelectric or thermal actuator.

In this case, there is one linear array of eye models but it should be understood that in other embodiments, the eye model testing platform may be similar to that shown in FIG. 7 but be designed for testing only 1 eye model while in other embodiments, the eye model testing platform may be similar to that shown in FIG. 7 but is expanded for testing more eye models which are laid out in an SxT planar matrix, where S and T are integers larger than 1.

The actuators 254 are mounted on the support member 252 in a desired format, which in this case is linear, and the motor 306 is coupled to the actuators 254 such that when the motor 306 provides a motive force to the actuators 254 then the eyeball member of each eye model can rotate in a desired direction during testing. Examples of eyeball member actuators that may be used with the eye model testing platform 250 are shown in FIGS. 8C and 8D.

The actuators 256 are mounted to the eyelid member of the eye models via a post 258, only one of which is numbered for ease of illustration. When the motor 308 provides a motive force to the actuators 256, the eyelid members may move in a linear up and down fashion during testing. Examples of eyelid member actuators that may be used with the eye model testing platform 250 are shown in FIGS. 8E and 8F.

Accordingly, in general, the eye model testing platform enables lateral movement and rotational movements for the eyelid and eyeball members, respectively. The speeds at which these two eye model members may move are chosen to correlate with the natural movements of a human or animal eye in order to emulate daily operation of the eye, or the use of any biomaterials with the eye. Examples of biomaterials include, but are not limited to, ocular inserts, contact lenses, and bandage lenses, for example.

Referring now to FIG. 8A, shown therein is an example embodiment a control system 300 that may be used with the eye model testing platform 250. The control system 300 may comprise a control unit 302 and a controller 304 for controlling the motors 306 and 308 so that the eye model members of the various eye models of the eye model testing platform operate in a certain manner during a test. The controller 304 may be modified to control fluid flow in embodiments where the eye model testing platform also includes a fluidic system.

The control unit 302 may be any computing device such as a laptop computer, a desktop computer, a mobile electronic device, such as a mobile phone, or any other suitable electronic device. The control unit 302 provides control signals to the controller 304. The controller 304 then sends control signals to the actuators of the eye model testing platform 252 to move the eye members of the various eye models in a desired manner. For example, the controller 304 may include circuits for blink pattern control. In some embodiments, the controller 204 may also issue control signals to control some aspect of fluid flow when or fluid composition when a fluidic system is used with the eye model testing platform.

In some embodiments, the control unit 302 may also receive information from the controller 304 such as data that may be collected by sensors when sensors are integrated with the eye model testing platform. For example, in cases where a fluidic system is integrated with the eye model testing platform, flow rate sensors, pressure sensors and/or chemical sensors may be used to detect the flow and composition or other characteristics of fluids that are passed through the eye model.

Referring now to FIG. 8B, shown therein is an example embodiment of the controller 330. The controller 330 may comprise a microcontroller 332 and a motor shield block 334. In other embodiments, the controller 330 may have a different configuration and different components.

The microcontroller 332 may comprise a data interpretation and processing block 336 and a data storage block 338 that are coupled to one another, possibly by a bus, for example. The data interpretation and processing block 336 may be implemented in various ways such as by using one or more processors, a microchip, or Application Specific Integrated Circuits (ASICs). The data storage block 338 may be implemented using known memory elements that are suitable for this particular application, such as EEPROM, flash memory and the like.

The data interpretation and processing block 336 may receive control signals from the control unit 302 to control the motors 306 and 308 in a desired manner. The data interpretation and processing block 336 may also receive information related to the motors 306 and 308 that may be used to indicate how the motors 306 and 308 are performing and whether different control signals should be sent to them.

The data storage block 338 may be used to store parameters that are used by the data interpretation and processing block 336 to control the motors 306 and 308 in a certain manner depending on the nature of the testing to be done by the eye model testing platform 250. The data storage block 338 may also store data that is obtained related to the tests or from the operation of the motors 306 and 308.

The motor shield block 334 is a separate component of the controller that is used to couple with the motors 306 and 308 to protect the microcontroller 332. Accordingly, the motor shield 334 may provide electrical shielding and include protective circuitry (not shown) to protect the microcontroller block 332 from danger conditions such as large transient currents or voltage spikes, as is known by those skilled in the art.

The motor shield block 334 further comprises a rotational motor control block 340 and a linear motion motor control block 342. The rotational motor control block 340 may be coupled to the motor 306 which is used to provide a motive force to rotate the eyeball member of the eye models in the eye model testing platform 250. The linear motion motor control block 342 may be coupled to the motor 308 which is used to provide a motive force to move the eyelid member of the eye models in the eye model testing platform 250 in a linear fashion to simulate eye blinking.

The rotational motor block 340 and the linear motion motor control block 342 may be implemented by using one or more circuit boards along with one or more processing circuitry and corresponding memory units. The processing circuitry and memory units may be implemented as was described for the data interpretation and processing block 336 and the data storage block 338, respectively. In some embodiments, a single circuit board having single processing circuitry and single memory unit may be used to implement both the rotational motor block 340 and the linear motion motor control block 342.

The memory elements of the rotational and linear motor control blocks 340 and 342 store instructions to implement motor drivers. During use, the processing circuitry then reads the instructions to send commands to the drive for each of the motors 306 and 308. The software instructions may be coded using appropriate software such as, but not limited to, Java, C, C++, C#, and the like. The software instructions include commands to control the motors 306 and 308 so that the eyeball members and the eyelid members move in a particular direction at a particular time. This may be achieved by sending signals having appropriate current and voltage levels as well as timing, which may depend on the type of motors that are used.

Referring now to FIGS. 8C and 8D, shown therein are example embodiments of eyeball member actuator assemblies 350 and 350′ that may be used with an eye model testing platform. The eyeball member actuator assemblies 350 and 350′ may be mounted on an interfacing device to transfer a motive rotational force from the motor 306 to the eyeball members during testing.

Referring now to FIG. 8C, the eyeball member actuator assembly 350 comprises a motor linkage 352 to the motor 306 (not shown). The motor linkage 352 is also coupled to one of the rotating members 354a to 354c in order to provide a rotational force to that member during testing or other use. The rotational members 354a to 354c are mounted on a platform 358. The rotational member that is coupled to the motor linkage 352 may be further coupled to the other rotational members in order to transfer the rotational force to them during use. For example, the rotational members 354a to 354c may be coupled by a belt (not shown) that encircles all of these members so that when the rotational member 354b rotates, for this example, the belt moves causing the rotational members 354a and 354c to also rotate.

The eyeball member actuator assembly 350 also comprises rods 356a to 356c that receive a rotational force from the rotational members 354a to 354c when driven by the motor 306 during use. The rods 356a to 356c are coupled to a center region of a back surface of the eyeball members so that the eyeball members rotate when the motor 306 provides a rotational motive force during use.

Referring now to FIG. 8D, the eyeball member actuator assembly 350′ is similar to the eyeball member actuator assembly 350 with similar elements being designated with similar reference numerals that are primed. However, in this example, the rods 356a to 356c have been replaced with eyeball member mounts that are circular containers which have receptacles that are dimensioned to provide a releasable and friction fit with the outer circumferential edges of the eyeball members so that a rotational force is provided to the eyeball members when the motor 306 provides a rotational motive force during testing.

Referring now to FIGS. 8E and 8F, shown therein are example embodiments of eyelid member actuator assemblies 360 and 360′ that may be used with an eye model testing platform. The eyelid member actuator assemblies 360 and 360′ may be mounted on an interfacing device to convert a motive rotational force from the motor 306 to a linear translation force and transfer this linear translation force to the eyelid members during testing.

Referring now to FIG. 8D, the eyelid member actuator assembly 350 comprises a motor linkage (not shown) to the motor 308 (not shown). The linkage is also coupled to an element that converts rotational force to linear translational force, which in this example is a rack and pinion 362. The rack and pinion 362 is coupled to a support member 364 having eyelid member mounts 366a to 366c. The eyelid member mounts 366a to 366c are circular containers which are dimensioned to provide a releasable friction fit when receiving the outer circumferential edges of the eyelid members. The elements 362 to 366c are mounted on a platform 368.

During use, the linear translational force that is derived from the rotational motive force provided by the motor 308 is transferred to the eyelid member mounts 366a to 366c via the support member 364. The linear translational force is transferred to the eyelid members from the eyelid member mounts 366a to 366c to move the eyelid members in a linear direction with respect to the eyeball members.

It should be noted that the eyelid actuator assembly 360 does not move the eyelid members up and down as would happen with in-vivo eyelid blinking, but instead the eyelid actuator 360 moves the eyelid members in the lateral direction. This motion is simpler to simulate and achieves the same effect as the vertical eyelid movement in the in-vivo case.

Referring now to FIG. 8E, the eyelid member actuator assembly 360′ is similar to the eyelid member actuator assembly 360 with similar elements being designated with similar reference numerals that are primed. However, in this example, the platform 368′ is wider than the platform 368 and there is additional support member 362s for the rack and pinion 362′.

It should be known that during use, one of the eyeball actuator assemblies 350 and 350′ are disposed with respect to one of the eyelid actuator assemblies 360 and 360′ so that the eyelid support members 356a to 356c or 356a′ to 356c′ are facing and aligned with the eyeball support members 366a to 366c or 366a′ to 366c′ so that they eyeball members and eyelid members of each eye model are facing one another and have a desired gap between them to allow for fluid flow during testing.

It should be noted that the embodiments of the eyeball and eyelid member actuators 350, 350′, 360 and 360′ shown in FIGS. 8C to 8F, are shown for example purposes only. It should be known that there may be other structures that may be used to provide the functionality of the eyeball and eyelid member actuators 350, 350′, 360 and 360′ and that these elements may be modified.

It should be understood that while the eye model testing platform has been described for testing several eye models simultaneously, there may be embodiments in which any of the eye models described herein are extended to comprise an eye movement unit that is configured to move at least one of the eyeball and eyelid members. The eye movement unit may comprise a control unit configured to control movement of at least one the eyelid and eyeball members; at least one actuator configured to move at least one of the eyelid and eyeball members; and at least one motor coupled to the control unit and the actuator. Each motor may be configured to receive control signals from the control unit to cause a corresponding actuator to move one of the eyelid and eyeball members in a linear motion or a rotational motion, respectively. The control unit may be implemented similarly to control unit 302 and the actuator may be implemented similarly to actuator assemblies 350, 350′, 360 and 360′ when modified for use with one eye model. Other control units or actuator assemblies may also be used.

Referring now to FIG. 8G, shown therein is a block diagram of a control unit 370 for controlling the eye model testing platform 250. The control unit 370 is provided as an example and there can be other embodiments of the control interface with different components or a different configuration of the components described herein. The control unit 370 further includes several power supplies (not all shown) connected to various components of the control unit 370 as is commonly known to those skilled in the art.

A user interacts with the control unit 370 to perform testing including movements for the eyeball model of at least one of the embodiments described herein. The movement testing may be to test CL interaction with eye movements, to test the effect of friction between the eyelid and the CL, to test the effects of air exposure to at least one of the eyeball and eyelid members, or to test how certain drugs behave under eye movement, for example. In some cases, there may be other operations or tests that may be performed as is known by those skilled in the art.

The control unit 370 comprises a processing unit 374, a display 376, a user interface 378, an interface unit 380, Input/Output (I/O) hardware 382, a wireless unit 384, a power unit 386 and a memory unit 388. The memory unit 388 comprises software code for implementing an operating system 390, various programs 392, an eye model testing module 394 and one or more databases 396. Many components of the control unit 370 can be implemented using a desktop computer, a laptop, a mobile device, a tablet, a phablet, a mobile phone and the like.

The processing unit 374 controls the operation of the control unit 370 and may be any suitable processor, controller or digital signal processor that can provide sufficient processing power processor depending on the configuration, purposes and requirements of the eye model testing platform 300 as is known by those skilled in the art. For example, the processing unit 374 may be a high performance general processor. In alternative embodiments, the processing unit 374 may include more than one processor with each processor being configured to perform different dedicated tasks. In alternative embodiments, specialized hardware may be used to provide some of the functions provided by the processing unit 374.

The display 376 may be any suitable display that provides visual information depending on the embodiment of the control unit 370. For instance, the display 376 may be a cathode ray tube, a flat-screen monitor and the like if the control unit 370 is associated with a desktop computer. In other cases, the display 376 may be a display suitable for a laptop, tablet or handheld device such as an LCD-based display and the like.

The user interface 378 may include at least one of a mouse, a keyboard, a touch screen, a thumbwheel, a track-pad, a track-ball, a card-reader, voice recognition software and the like, again depending on the particular implementation of the control unit 370. In some cases, some of these components may be integrated with one another.

The interface unit 380 may be any interface that allows the control unit 370 to communicate with other devices or computers. In some cases, the interface unit 380 may include at least one of a serial port, a parallel port or a USB port that provides USB connectivity. The interface unit 380 may also include at least one of the Internet, a Local Area Network (LAN), Ethernet, Firewire, a modem or digital subscriber line connection. Various combinations of these elements may be used within the interface unit 380.

The I/O hardware 382 is optional and may include, but is not limited to, at least one of a microphone, a speaker and a printer, for example.

The wireless unit 384 may be optional and can be a radio that communicates utilizing CDMA, GSM, GPRS or Bluetooth protocol according to standards such as IEEE 802.11a, 802.11b, 802.11g, or 802.11n. The wireless unit 384 may be used by the control unit 370 to communicate with other devices or computers.

The power unit 386 may be any suitable power source that provides power to the control unit 370 such as a power adaptor or a rechargeable battery pack depending on the implementation of the control unit 370 as is known by those skilled in the art.

The memory unit 388 may include RAM, ROM, one or more hard drives, one or more flash drives or some other suitable data storage elements such as disk drives, etc. The memory unit 388 is used to store the operating system 390 and programs 392 as is commonly known by those skilled in the art. For instance, the operating system 390 provides various basic operational processes for the control unit 370. The programs 392 include various user programs so that a user can interact with the control unit 370 to perform various functions, which are generally known by those skilled in the art.

The eye model testing module 394 may be used for performing certain types of tests on an eye model. Accordingly, the eye model testing module 394 may be used for various purposes such as, but not limited to, changing test parameters for eye model testing including fluid rate (if fluid systems are included in the actuation system), selecting movement speed for the eyeball member, selecting movement type for the eyeball member (rolling and/or moving to at least one of the left, right, top and bottom), selecting blinking speed for the eyelid member, running certain types of tests as was described previously, collecting test result data and analyzing the test result data. Other types of tests may include testing that mimics the daily operation of the eye in terms of how many times the eye blinks during the day, and testing how much the eyeball moves during sleep.

In one example embodiment, the eye model testing module 394 may comprise a first act that involves selecting a particular test that is followed by another act in which values for various parameters related to that test may be entered or selected from predetermined values. The eye model testing platform may then be physically setup according to desired test parameters such as coupling a fluidic system when the eye models are tested with fluid and/or setting the size of the gap between the eyelid and eyeball members 12 and 14 (in some cases the gap may be set manually and in some cases the gap may be set electronically depending on the type of gap member that is used to provide the gap). The testing may then be performed and certain data may be recorded, again depending on the type of test done and whether any sensors are used with the eye models. The recorded data may then be complied into a report that may include graphs or the calculation of certain performance criteria. The test report may then be provided for review by outputting the test report on the display 376, printing the test report via the I/O hardware 382 or emailing the test report to a user via the wireless unit 384 or the interface unit 380. The test report may also be saved in one of the databases 396.

The eye model testing module 394 is typically implemented using software, but may be implemented using hardware such as, but not limited to, FPGA or application specific circuitry in some cases, for example.

The databases 396 may be used to store data for the control unit 370 such as, but not limited to, system settings, parameter values, calibration data, and test results. The databases 396 may also store other information required for the operation of the eye model testing module 394, the programs 392 and the operating system 390 such as dynamically linked libraries and the like.

The control unit 370 generally comprises at least one interface that the processing unit 374 may communicate with in order to receive or send information. This interface may be the user interface 378, the interface unit 380 or the wireless unit 384. For instance, information for calibrating eye model testing may be inputted by someone through the user interface 378 or it can be received through the interface unit 380 from a computing device, or another electronic device such as an external memory device like a USB key or an external hard drive, for example. The processing unit 374 may communicate with either one of these interfaces as well as the display 376 or the I/O hardware 382 in order to output information related to the eye model tests. In addition, users of the control unit 370 may communicate information across a network connection to a remote system for storage and/or further analysis. This communication may include email or network communication.

Corneal foreign body removal (FBR) is a procedure to remove foreign objects, such as a piece of metal, wood, plastic or sand, attached superficially or embedded in the cornea of the eye¹⁰. If the foreign object is not removed in an appropriate and timely manner, the foreign object can then cause ocular pain, infections and/or necrosis. As such, the instruction of corneal FBR is considered to be highly important in ophthalmic training^{11, 12.} Unfortunately, due to the lack of satisfactory instructional models that are available, there are insufficient opportunities for students to gain practical experience in corneal FBR in many education/training programs.

For example, bovine eyes are the current preferred choice for teaching and practicing FBR^{13, 14}. The preparation of the eye for FBR involves the use of an angle grinder to generate multiple metallic bodies of different sizes, which embeds randomly into the corneal and conjunctival regions of the eye¹³. The bovine eye model provides an inexpensive model to allow students to develop the manual skills needed for FBR^{13, 14}. However, bovine eyes are still relatively difficult to obtain on a large scale, which limits the amount of FBR that a student can perform.

There are other eye models that have been explored for FBR including pig corneas and gelatin eye models. Unfortunately, the pig eyes are too rubbery for insertion of foreign bodies, while gelatin is considered too hard¹⁵. A simpler model, in which glass spheres are coated with paraffin and small metal pieces are embedded within the paraffin, provides a more reliable eye model for FBR¹⁵. Still, this particular eye model may be too simple and cannot mimic the consistency of the cornea and conjunctiva of an actual eye.

In accordance with the teachings herein, there is provided an inexpensive and simple method to produce a high quantity of eye models for FBR. The eye mold can be filled with any polymer mimicking the eye, such as agarose, at different concentrations to mimic the varying consistency of the cornea and conjunctiva. The foreign body may be embedded within the eye model during the gelation process.

Referring now to FIG. 9, shown therein is an eyeball member 400 having different concentrations of agarose for different regions of the eyeball member including the epithelium 402, the cornea 404 and the sclera 406. The eyeball member 400 also includes foreign objects 408 that are embedded in various regions of the eyeball member 400. In this example, the foreign objects 408 are embedded in a region of the epithelium and a region of the sclera. Due to the use of the eyeball member 400 having different regions that match an actual human eye, the eyeball member 400 with the foreign objects 408 provides a more realistic training tool. To simulate the different regions of the eyeball, different concentrations of agarose can be used. For example, the sclera may contain a concentration of agarose at 2-4 g/mL, the cornea at 1-2 g/mL, and the epithelium at 0.5-1 g/mL. Other concentrations may be used depending on the application in which the eyeball may be used.

It should also be understood that at least some of the elements described herein that are at least partially implemented via software may be written in a high-level procedural language such as object oriented programming or a scripting language. Accordingly, the program code may be written in at least one of C, C⁺⁺, SQL or any other suitable programming language and may comprise modules or classes, as is known to those skilled in object oriented programming. It should also be understood that at least some of the elements of the eye model testing platform that are implemented via software may be written in at least one of assembly language, machine language or firmware as needed. In either case, the program code can be stored on a storage media or on a computer readable medium that bears computer usable instructions for one or more processors and is readable by a general or special purpose programmable computing device having at least one processor, an operating system and the associated hardware and software that is necessary to implement the functionality of at least one of the embodiments described herein. The program code, when read by the computing device, configures the computing device to operate in a new, specific and predefined manner in order to perform at least one of the methods described herein.

Furthermore, the computer readable medium may be provided in various non-transitory forms such as, but not limited to, one or more diskettes, compact disks, tapes, chips, USB keys, magnetic and electronic storage media and external hard drives or in various transitory forms such as, but not limited to, wire-line transmissions, satellite transmissions, internet transmissions or downloads, digital and analog signals, and the like. The computer useable instructions may also be in various forms, including compiled and non-compiled code.

While the applicant's teachings described herein are in conjunction with various embodiments for illustrative purposes, it is not intended that the applicant's teachings be limited to such embodiments. On the contrary, the applicant's teachings described and illustrated herein encompass various alternatives, modifications, and equivalents, without generally departing from the embodiments described herein.

### REFERENCES

1. Subbaraman L. N., Glasier M. A., Senchyna M., Sheardown H., and Jones L. (2006). Kinetics of in vitro lysozyme deposition on silicone hydrogel, PMMA, and FDA groups I, II, and IV contact lens materials. Curr Eye Res, V. 31, pp. 787-796.
2. Lorentz H., Rogers R., and Jones L. (2007) The impact of lipid on contact angle wettability. Optom Vis Sci, V. 84, pp. 946-953.
3. Phan C. M., Subbaraman L. N., and Jones L. (2013) In vitro uptake and release of natamycin from conventional and silicone hydrogel contact lens materials. Eye Contact Lens, V. 39, pp. 162-168.
4. Hui A., Boone A., and Jones L. (2008) Uptake and release of ciprofloxacin-HCl from conventional and silicone hydrogel contact lens materials. Eye Contact Lens, V.34, pp. 266-271.
5. Peng C. C., Kim J., and Chauhan A. (2010) Extended delivery of hydrophilic drugs from silicone-hydrogel contact lenses containing vitamin E diffusion barriers. Biomaterials, V. 31, pp. 4032-4047.
6. Boone A., Hui A., and Jones L. (2009) Uptake and release of dexamethasone phosphate from silicone hydrogel and group I, II, and IV hydrogel contact lenses. Eye Contact Lens, V. 35, pp. 260-267.
7. Karlgard C. C., Jones L. W., and Moresoli C. (2003) Ciprofloxacin interaction with silicon-based and conventional hydrogel contact lenses. Eye Contact Lens, V. 29, pp. 83-89.
8. Mishima S., Gasset A., Klyce S. D., Jr., and Baum J. L. (1966) Determination of tear volume and tear flow. Invest Ophthalmol, V. 5, pp. 264-276.
9. Furukawa R. E., and Poise K. A. (1978) Changes in tear flow accompanying aging. Am J Optom Physiol Opt, V. 55, pp. 69-74.
10. Babineau M. R., and Sanchez L. D. (2008) Ophthalmologic procedures in the emergency department. Emerg Med Clin North Am, V. 26, pp. 17-34, v-vi.
11. Spivey B. E. (1970) Ophthalmology for Medical Students—Content and Comment. Archives of Ophthalmology, V. 84, pp. 368-375.
12. Mccarthy W. H., Donaldson E. J., and Hollows F. C. (1977) What Should We Teach—Consensus Method to Determine Curriculum Content. Medical Education, V. 11, pp. 249-256.
13. Collins D. W., and Coroneo M. T. (1994) Removal of corneal foreign bodies: an instructional model. Ophthalmic Surg, V. 25, pp. 99-101.
14. Coroneo M. T. (1990) The Bovine Eye as a Model for the Novice Cataract Surgeon. Ophthalmic Surgery and Lasers, V. 21, pp. 772-777.
15. Austin P. E., Ljung M., and Dunn K. A. (1995) A new model for teaching corneal foreign body removal. Acad Emerg Med, V. 2, pp. 831-834.

1. An eye model for simulating an eye, wherein the eye model comprises:
an eyelid member having a concave inner surface to simulate an inner surface of an eyelid; and
an eyeball member having a rounded surface for simulating an eyeball and being sized to be releasably received within the concave inner surface of the eyelid member.

2. The eye model of claim 1, wherein the eyelid member and the eyeball member have a vertical orientation.

3. The eye model of claim 1, wherein at least one of the eyelid member and the eyeball member are made of polymers comprising at least one of Agar, protein derived polymers, synthetic polymers, polysaccharides, synthetic polymers, hydrogel polymers and elastomers.

4. The eye model of claim 1, wherein at least one of the eye members comprise one or more functional layers on an outer surface thereof.

5. The eye model of claim 4, wherein the one or more functional layers comprise at least one of collagen, a combination of epithelial cells and collagen, hydrophobic species, hydrophilic species, hydrophobic species, lipids and proteins.

6. The eye model of claim 1, wherein the eye model further comprises an eye model holder that releasably holds the eyelid and the eyeball members slightly apart from each other to provide a channel therebetween having a channel inlet and a channel outlet.

7. The eye model of claim 6, wherein the eye model holder comprises a body having an upper surface and lower legs that have flat lower surfaces to provide a stable surface for the eye model holder to stand in an upright position, the legs having inner side walls and the body a having a lower surface that collectively define a cavity to releasably fixedly receive the eye ball and eyelid members.

8. The eye model of claim 6, wherein the eye model holder comprises:
two holder portions for holding the eyeball and eyelid members, respectively, the two holder portions having flat lower surfaces to provide a stable support and upper surfaces that are shaped for releasably holding the eyeball and eyelid members, respectively; and
at least one gap member for setting a width for a gap between surfaces of the eyelid and eyeball members that face each other.

9. The eye model of claim 6, wherein the eye model further comprises a fluid system including:
a fluid source coupled to the channel inlet of the channel between the eyeball members for providing fluid thereto during testing; and
a collection well coupled to the channel outlet for receiving the fluid during testing.

10. The eye model of claim 1, wherein the eyeball member comprises a porous surface layer and an intravitreal space having at least one of a cavity and a porous network.

11. The eye model of claim 10, wherein the eyeball piece comprises poloxamers to create at least one of the cavity and the porous network.

12. The eye model of claim 1, wherein the eye model further comprises an eye movement unit to move at least one of the eyeball and eyelid members relative to one another.

13. The eye model of claim 12, wherein the eye movement unit comprises:
a control unit configured to control movement of at least one the eyelid and eyeball members;
at least one actuator configured to move at least one of the eyelid and eyeball members; and
at least one motor coupled to the control unit and the at least one actuator, the at least one motor being configured to receive control signals from the control unit to cause the at least one actuator to move at least one the eyelid and eyeball members.

14. The eye model of claim 1, wherein the eyeball member comprises at least one foreign body.

15. The eye model of claim 1, wherein the eye model comprises materials allowing the eye model to be used for at least one of drug discovery, microbiology and toxicology testing.

16. The eye model of claim 1, wherein the eyeball member comprises a support region, an indented region formed at a top portion of the support region and a cornea region formed at a central portion of the indented region.

17. The eye model of claim 1, wherein the eyeball member comprises a support region, an indented region formed at a top portion of the support region and a flat region formed at a central portion of the indented region.

18. A method for fabricating an eye model, the method comprising:
producing an eyelid member having a concave inner surface to simulate an inner surface of an eyelid; and
producing an eyeball member having a rounded surface for simulating an eyeball and being sized to be releasably received within the concave inner surface of the eyelid member.

19. The method of claim 18, wherein the method further comprises using at least one of Agar, protein derived polymers, synthetic polymers, polysaccharides, synthetic polymers, hydrogel polymers and elastomers to fabricate the eyelid and eyeball members.

20. The method of claim 18, wherein the method comprises forming at least one functional layer on at least one of the eye members.

21. The method of claim 20, wherein the forming of the at least one functional layer comprises using at least one of collagen, a combination of epithelial cells and collagen, hydrophobic species, hydrophilic species, hydrophobic species, lipids and proteins.

22. The method of claim 21, wherein the functional layers are fabricated using at least one of spin coating, dip coating, plasma treatment, and gas treatment depending on the materials used for the eyeball and eye lid members.

23. The method of claim 18, wherein the method further comprises:
forming an eye model holder that releasably holds the eyelid and the eyeball members slightly apart from each other to provide a channel therebetween having a channel inlet and a channel outlet.

24. The method of claim 18, wherein the method comprises forming the eyeball piece with an intravitreal space comprising at least one of a cavity and a porous network.

25. The method claim 24, wherein the method comprises using poloxamers to create at least one of the cavity and the porous network.

26. The method of claim 18, wherein the method comprises inserting at least one foreign body in the eyeball member.

27. The method of claim 18, wherein the eyelid and eyeball members are fabricated using 3D printed molds.

28. The method of claim 18, wherein the members are fabricated using direct 3D printing of polymer materials.

29. The method of claim 18, wherein the eye model is fabricated from materials that allow the eye model to be used for at least one of drug discovery, microbiology and toxicology testing.
